(19) United States
(12) Patent Application Publication
(10) Pub. No.: US 2020/0258426 A1
(43) Pub. Date: Aug. 13, 2020

(54) Uterine Model With Pathology

(71) Applicant: Caldera Medical, Inc., Agoura Hills, CA (US)

(72) Inventor: Jose Luis Charvet, Agoura Hills, CA (US)

(73) Assignee: Caldera Medical, Inc., Agoura Hills, CA (US)

(21) Appl. No.: 16/785,460

(22) Filed: Feb. 7, 2020

Related U.S. Application Data
(60) Provisional application No. 62/803,358, filed on Feb. 8, 2019.

(51) Int. Cl. G09B 23/32

(52) U.S. Cl. CPC G09B 23/32

(57) ABSTRACT

A synthetic model of a uterine cavity having deflated and inflated configuration that simulate the normally flat configuration of a human uterus. Pathologies may be provided within the model and an access for an instrument, such as a hysteroscope, is provided such that, in the deflated configuration, a view or access to the pathology is at least partially obstructed by the cavity walls, requiring a user of the model to inflate the cavity to the inflated configuration.

### RELATED APPLICATIONS

This application claims priority to U.S. Provisional Application Ser. No. 62/803,358 filed Feb. 8, 2019 entitled Uterine Model With Pathology, which is hereby incorporated herein by reference in its entirety.

### FIELD OF THE INVENTION

The present invention relates to the field of uterine models with pathology that provide a simulated environment of the human uterus which is capable of uterine distention and collapse.

### BACKGROUND OF THE INVENTION

Hysteroscopes, tissue removal devices and fluid management systems used to remove polyps and myomas in the uterus, need to be evaluated for visualization, cutting ability, and fluid balance to properly assess their capabilities and performance. Unfortunately, obtaining cadaveric human or animal pathologies are difficult because pathologies can only be identified by subjecting them to medical radiological instruments, a random and expensive ordeal. As such, usually synthetic models are used to simulate a uterus.

Several uterine models exist. However, none represent the dynamics of uterine distention and collapse. The human uterus is generally a flat, fan shaped organ capable of expanding. It is further compressed by other neighboring organs. Removal of uterine pathologies such as polyps and fibroids often require the physician to visualize the pathology, provide clearance for instruments such as tissue removal devices, and enable continuous fluid flow inside the uterus to move cut pathologies and clear the environment from blood. Therefore, uterine distention is critical to the proper function of the instrumentations. Proper distention requires a fine balance between the geometry and material properties of the uterus as well as the fluid mechanics passing inside the uterus.

In parallel, several synthetic pathologies are currently available, but none represent the modulus of elasticity found in polyps and myomas that were clinically tested.

Hence, what is needed in the art is a uterine model with pathology that more accurately creates an environment that is similar to a human uterus and synthetic pathologies that better represent those found in the clinical setting by, for example, allowing the pathology to sway with respect to the fluid flow inside the uterine model. Such uterine and pathology models can be used for validation testing of hysteroscopes, tissue removal devices and fluid management systems as well as user and sales representative training.

### BRIEF SUMMARY OF THE INVENTION

The present invention is directed to meeting the aforementioned needs by providing a device and method for providing a uterine model with pathology that more accurately creates an environment similar to human anatomy.

One aspect of the invention provides a uterine model that includes a proximal portion with a rigid portion defining a cavity shaped to mimic a human uterus and including a terminal end defining an opening, the terminal end mimicking a human cervix; at least one elastic portion connected to the rigid portion and partially defining the cavity; and a distal portion configured to mate with the proximal portion and to hold a synthetic pathology model between the distal portion and the proximal portion in a sealed manner such that fluid injected into the cavity does not leak out of the cavity around the pathology. When liquid is injected into said cavity through said opening, said elastic portions expand due to fluid pressure, at least partially separating said elastic portions from said pathology.

In one aspect, the uterine model further comprises a base removably supporting the proximal portion and the distal portion.

In another aspect the distal portion and the proximal portion are configured to mate using threaded features.

In still another aspect, the at one elastic portion comprises two elastic portions.

In still another aspect, the at least one elastic portion comprises silicone rubber.

In yet another aspect, a longitudinal axis of the pathology and a longitudinal axis of the proximal portion are aligned.

In still another aspect, a longitudinal axis of the pathology and a longitudinal axis of the proximal portion are perpendicular.

In one aspect the pathology may be a somewhat spherical shape representing a myoma.

In yet another aspect, the pathology comprises one or more elongate features representing polyps.

In still another aspect of the invention, a uterine model is provided including a first structure defining a cavity representing a uterus, the cavity at least partly defined by elastic portions that give the cavity a deflated configuration and an inflated configuration; a second structure removably placeable within the cavity and including a component representing a pathology; wherein when the second structure is placed within the first structure, liquid may be introduced into the cavity to inflate the cavity from the deflated configuration to the inflated configuration.

The uterine model may include a hole at a terminal end of the first structure and sized to receive an instrument useable for inflation of the cavity and having an imagining capability.

In the deflated configuration, a view of the pathology through the instrument may be at least partially obstructed by the first structure.

In one aspect, when the uterine model is in the inflated configuration, a view of said pathology through the instrument is less obstructed by the first structure than in the deflated configuration.

The second structure may include a pathology removably connected to a housing. The housing may be threadably connectable to the first structure.

The first structure may have a rigid portion and at least one elastic portion.

Another aspect of the invention provides a method of simulating a uterine medical procedure that includes: providing a synthetic model of a uterine cavity; introducing an instrument into the uterine cavity; using the instrument to inject a liquid into the cavity until the cavity expands from a deflated configuration to an inflated configuration. A procedure may then be performed within the cavity with an instrument. Further, a synthetic pathology model may be provided within the cavity, and a procedure may be performed on the synthetic pathology.

In some embodiments, the cap of the removable housing is taller to cover all stock of the fibroid/polyp after assembly. In some embodiments, the cap is flush with the uterine model after locking down.

According to some embodiments, the cap of the removable housing has an improved threaded form to tightly seal the mating components. In some embodiments, the cap is a two-piece assembly.

In some embodiments, the uterine model provides two configurations; a side pathology location (as current design) or a Fundal pathology location.

In some embodiments, the uterine model withstands a pressure of 150 mmHg.

In some embodiments, the uterine model may withstand under varying pressure conditions up to 150 mmHg after 1 hour of use.

In some embodiments, the hole for the cervix may be undersized to keep a 5.8 mm hysteroscope from leaking fluid therefrom.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1A is an exterior perspective and side view of one embodiment of a uterine model with pathology in a non-distended state according to the present invention;

FIG. 1B is an exterior perspective and side view of one embodiment of a uterine model with pathology in a non-distended state according to the present invention;

FIG. 1C is a cross-sectional view of one embodiment of a uterine model with pathology in a non-distended state according to the present invention;

FIG. 1D is an exterior perspective and side view of one embodiment of a uterine model with pathology in a non-distended state according to the present invention;

FIG. 1E is an exterior perspective and side view of one embodiment of a uterine model with pathology in a non-distended state according to the present invention;

FIG. 2 is a perspective view of one embodiment of the rigid portion of the uterine model comprising a main structure and two frames according to the present invention;

FIG. 3 is a perspective view of one embodiment of the removable housing of the uterine model according to the present invention;

FIG. 4 is a perspective view of one embodiment of the removable housing of the uterine model with a support base according to the present invention;

FIG. 5A is a cross-sectional view of one embodiment of a uterine model pathology in a distended state according to the present invention;

FIG. 5B is a cross-sectional view of another embodiment of a uterine model pathology in a distended state according to the present invention;

FIG. 6A is a perspective view of one embodiment of the uterine model with pathology in a non-distended state according to the present invention;

FIG. 6B is a cross-sectional view of one embodiment of the uterine model with pathology in a non-distended state according to the present invention;

FIG. 7 is a perspective view of a multistrand polyp according to the present invention;

FIG. 8A is a view of an interior of one embodiment of the uterine model with pathology in a non-distended state from a hysteroscope according to one embodiment of the present invention;

FIG. 8B is a view of an interior of one embodiment of the uterine model with pathology in a partially distended state from a hysteroscope according to one embodiment of the present invention; and,

FIG. 8C is a view of an interior of one embodiment of the uterine model with pathology in a distended state from a hysteroscope according to one embodiment of the present invention.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

The uterine model with pathology presented here will be able to test the ability of hysteroscope and fluid management systems to distend and maintain intrauterine pressure during a diagnostic portion of the surgery. For instance, when the uterus is in its collapsed, non-distended state, the hysteroscope will not be able to see the pathology in full view. Once the fluid media is pushed by the fluid management system into the hysteroscope, the uterine model will expand its elastic portion to represent distention. The model will also be able to test the ability of the tissue removal device and fluid management system to remove and irrigate pathologies and the fluid media during the therapeutic portion of the surgery. It is always important to maintain a certain distention during the therapeutic procedure, and the uterine model presented here will test if the instruments will be able to do perform such.

The uterine model with pathology was invented to create a simulated environment the same as a human uterus. It can be used for validation testing of hysteroscopes, tissue removal devices (TRDs) and fluid management system as well as user and sales representative training.

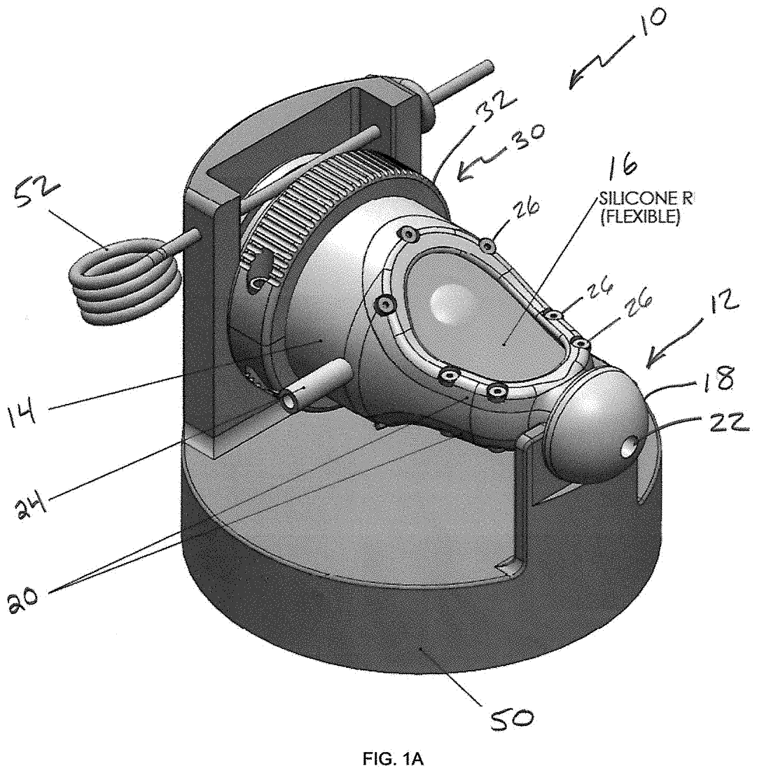

FIG. 1A shows an exterior view of an embodiment 10 of a simulated uterine model. The proximal portion 12 of the model comprises a rigid portion 14, for example, a 3D printed plastic portion and an elastic portion 16 made of, for example, silicone rubber. The distal portion 30 of the model comprises a removable housing 32 that holds the synthetic pathology 60 (FIG. 1C), for example, synthetic human polyps and myomas.

The proximal rigid portion 12 further tapers to a mushroom shaped terminal end 18 which mimics the cervix of a human body. The rigid portion 14 further includes a main structure and two frames 20 to capture the elastic silicone rubber portion 16. The simulated uterine model further comprises a support base 50 to hold the entire assembly of rigid portion and removable housing in firm positions during simulated removal of uterine pathologies such as polyps and fibroids and enabling continuous fluid flow inside the simulated uterus to move cut pathologies. The flared distal end of the removable housing of the uterine model pathology 60 is firmly attached with the support base with a locking clip 52 that prevents the distal portion 30 from being lifted out of the base 50.

FIG. 1A further shows a hole 22 at the tapered proximal end of the rigid portion of the simulated uterine model which may be used as a point of entry for hysteroscopes and tissue removal devices. The hole 22 may be undersized to keep a 5.8 mm hysteroscope from leaking.

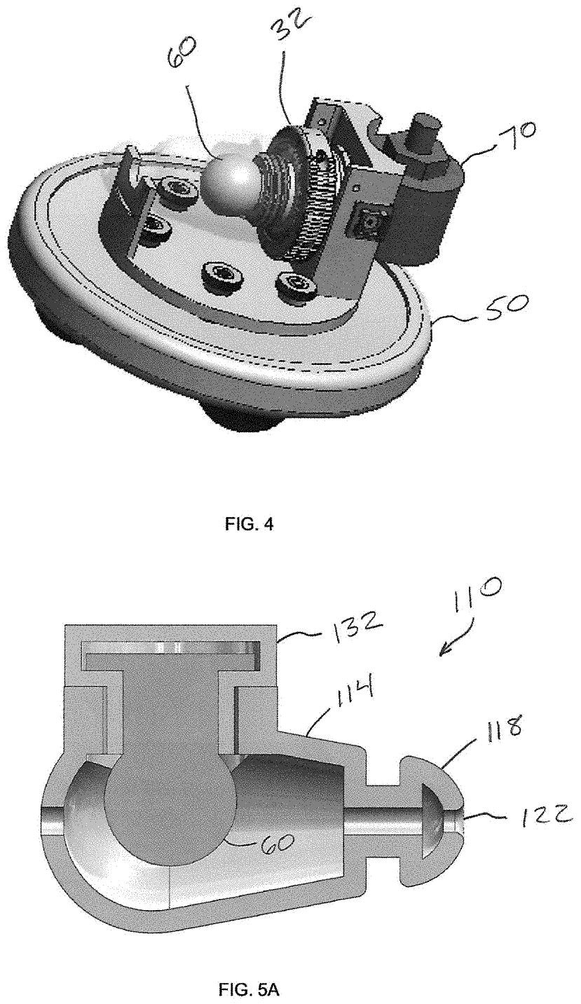

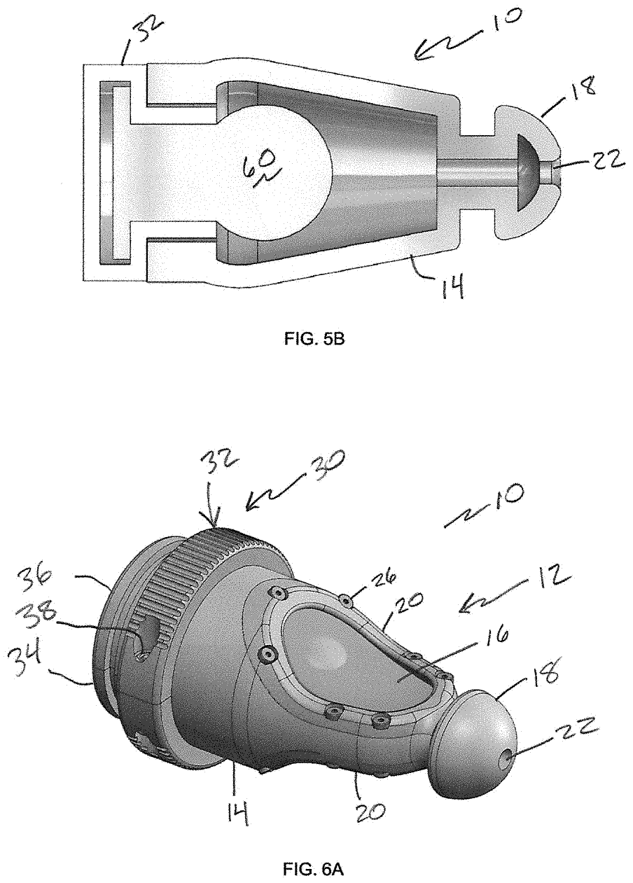

The uterine model in its initial state represents the uterus in a collapsed, non-distended state (FIGS. 1A-1E, 6A, and 6B). When the fluid media is pushed by the fluid management system into the simulated uterine model, the elastic portion 16 will expand to its elastic state to represent distention (FIG. 5A). The collapsed region is represented by ⅔ the length of the uterus, a non-collapsed region near the distal portion 30 holds the pathology 60. With the application of internal fluid pressure between 20-150 mmHg, the uterine model distends to show uterine pathologies located behind the collapsed uterine wall. The uterine model has an internal volume that represents a normal uterine volume.

The elastic portion 16 of the uterine model has a material property that matches the human uterus. The material that is used to make the uterine model must have an elastic tensile/compressive modulus ˜34 kPa. This represents the average of the parallel and perpendicular uterine tissues measured by Kiss et al. The material used in this invention, provided by Remedy, is 38 kPa (5 mm thick sheet) which is close to the required thickness of the uterine tissues measured by Kiss et al.

As can be seen in FIG. 1A, the rigid portion 14 further employs a lateral port 24 with a lumen to allow measurement of intrauterine pressure. The port 24 may be embodied as a hose or tube for introducing the pressure sensor into the intrauterine cavity 17 (FIG. 1C) for the measurement of intrauterine pressure.

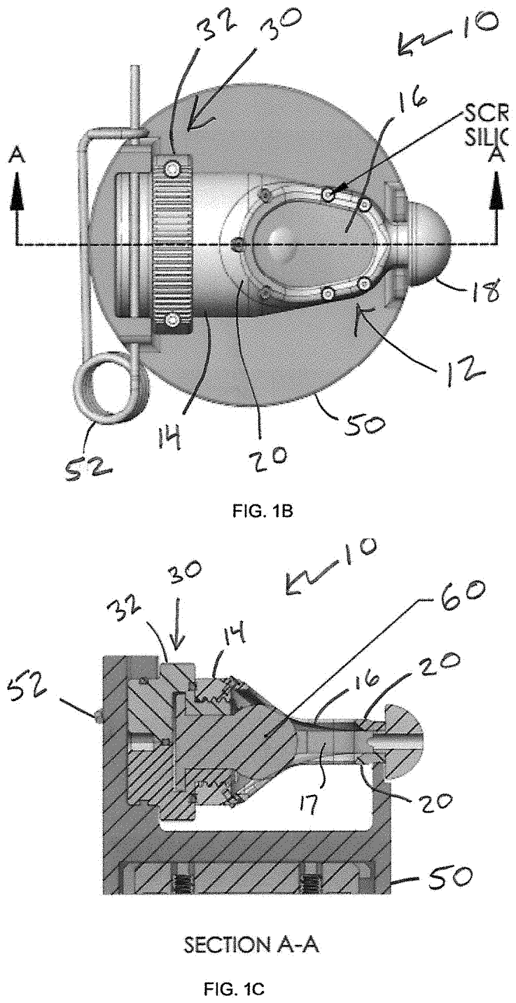

FIG. 2 shows the proximal portion 12 separated from the rest of the device 10. The proximal portion 12 includes a rigid portion 14 of the uterine model which comprises a main structure and two frames 20 to capture the elastic portion 16. The frames are attached to the main structure by threaded locking elements 26. The rigid portion further has an internal threaded feature 28 to connect the removable housing for the pathologies.

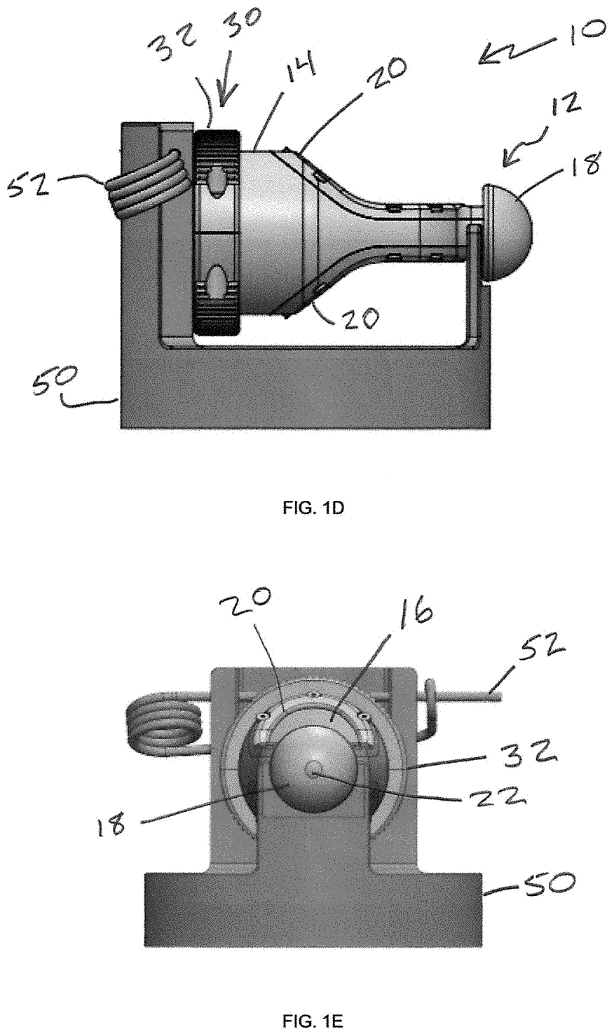

FIG. 3 shows the distal portion 30 separated from the rest of the device 10. The distal portion 30 is a removable housing 32 of the simulated uterine model that holds the synthetic pathology 60, for example, synthetic polyps and myomas. FIG. 3 further shows that the removable housing 32 that comprises a cap having a first half 34 and a second half 36 (shown as opaque and transparent portions) which are connected by threaded locking elements 38, for example, threaded screws and sealing elements 40, for example, a gasket. The first half and a second half of the removable housing further have a u-shaped cavity for multiple straight sealing elements or gaskets. The first half and a second half of the removable housing also have a circular portion for a circular sealing element. The removable housing further has a mating threaded base 42 to connect it with the threaded rigid portion 28 of the proximal portion 12.

FIG. 3 further shows that the removable housing 32 has a neck that holds the pathology 60 flush to the bottom to represent Type II myomas in sphere shape. The removable housing 32 has geometric features that allows mounting the uterine model horizontally in a dedicated fixture rigidly.

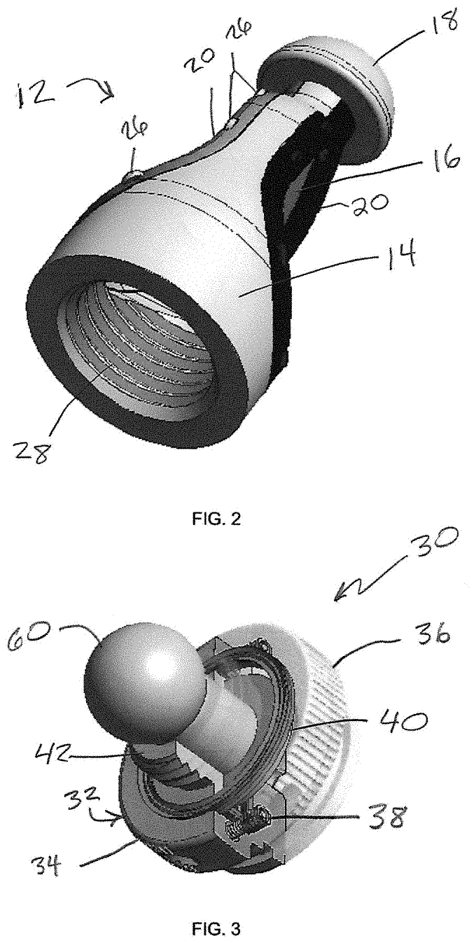

FIG. 4 shows the removable housing 32 holding the synthetic pathology 60 flush to the bottom and the entire unit is firmly attached on a support base 50. A pressure sensor 70 is shown to the right of the support base.

FIG. 5A shows a cutaway view of an alternative embodiment 110 of the device of the invention in which the pathology 60 has a longitudinal axis that is perpendicular to the longitudinal axis of the rigid portion 112 of the proximal section 114.

FIG. 5B shows a similar cross-sectional view to that of 5A except that it depicts embodiment 10 of the uterine model. In both FIGS. 5A and 5B, the removable housing 132, 32, is threaded with the rigid portion 114, 14 respectively.

FIG. 6A is a perspective view of embodiment 10 shown with the base removed in order to show the assembled distal portion 30 and proximal portion 12.

FIG. 6B is a cutaway of the view of FIG. 6A showing the pathology 60 and the connecting features 28 and 42 of the proximal portion 12 and the distal portion 30, respectively.

In some embodiments, the present invention features a uterine model having a pathology located at the fundal wall. In some embodiments, synthetic materials that match the static and dynamic elastic modulus of human polyps and myomas are employed.

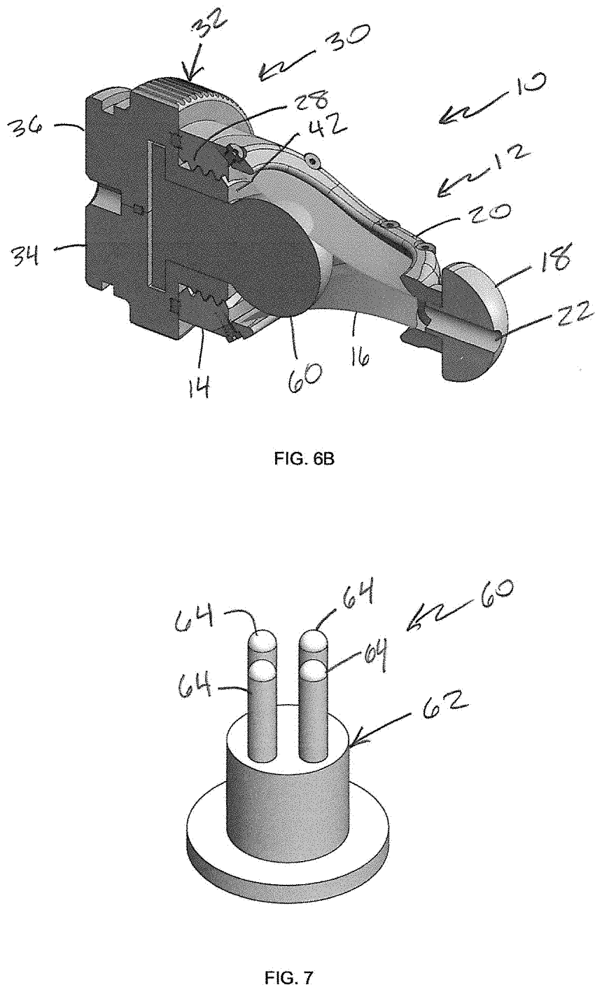

According to some embodiments, as shown in FIG. 7, a pathology 60 is presented that is embodied as a synthetic polyp 62 having strands 64 that are 5 mm in diameter and an aspect ratio that allows each strand to sway with respect to the fluid flow inside the uterus are disclosed. In some embodiments, synthetic myomas having 3 cm sphere diameters are disclosed.

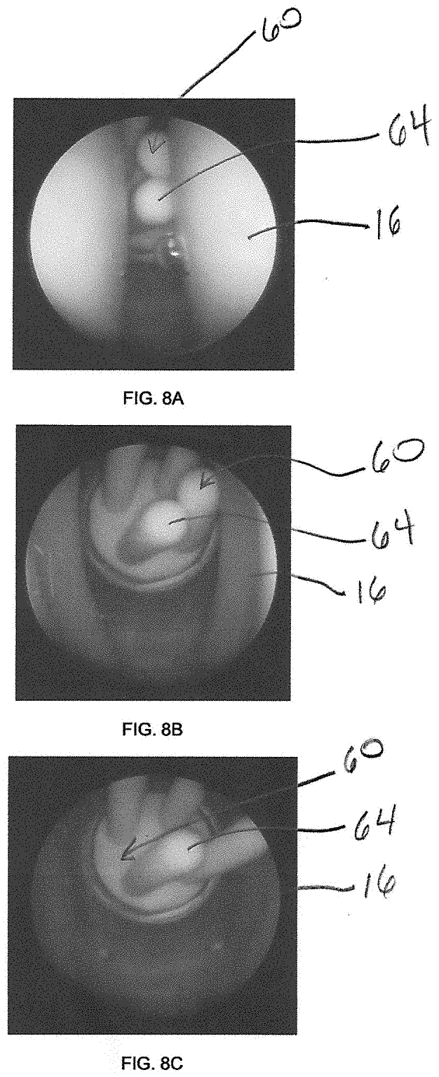

FIGS. 8A through 8C show a view from a same hysteroscope inserted into the inventive uterine model with pathology progressing from a non-distended (FIG. 8A) to a partially distended (FIG. 8B) to a distended (FIG. 8C) uterine model state.

Having described the various embodiments of the invention, a method of using the device is now described. In one example involving a diagnostic hysteroscopy, a hysteroscope is introduced into opening 22 of the terminal end 18. Saline or a similar liquid is introduced through the hysteroscope into the uterine cavity while pressure data is being recorded by the pressure sensor 70. As the cavity fills, the elastic portion 16 will expand and separate from the pathology, allowing a view of the pathology 60 through the hysteroscope. Once the diagnostic hysteroscopy is complete, the hysteroscope may be used to vacuum the saline out of the cavity.

If an operative hysteroscopy is to be performed, a hysteroscope or TRD is placed through the opening 22 of the terminal end 18. Saline or similar liquid is introduced and removed constantly such that irrigation and tissue removal is established. The TRD is used to remove pieces of the pathology 60, whether in the form of a myoma or polyps. The hysteroscope may be used to view the progress or may be equipped with tissue removal capabilities.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A uterine model comprising:
a proximal portion including:
a rigid portion defining a cavity shaped to mimic a human uterus and including a terminal end defining an opening, the terminal end mimicking a human cervix;
at least one elastic portion connected to the rigid portion and partially defining the cavity;
a distal portion configured to mate with the proximal portion and to hold a synthetic pathology model between the distal portion and the proximal portion in a sealed manner such that fluid injected into the cavity does not leak out of the cavity around the pathology;
wherein when liquid is injected into said cavity through said opening, said elastic portions expand due to fluid pressure, at least partially separating said elastic portions from said pathology.

2. The uterine model of claim 1 further comprising a base removably supporting the proximal portion and the distal portion.

3. The uterine model of claim 1 wherein the distal portion and the proximal portion are configured to mate using threaded features.

4. The uterine model of claim 1 wherein the at one elastic portion comprises two elastic portions.

5. The uterine model of claim 1 wherein the at least one elastic portion comprises silicone rubber.

6. The uterine model of claim 1 wherein a longitudinal axis of the pathology and a longitudinal axis of the proximal portion are aligned.

7. The uterine model of claim 1 wherein a longitudinal axis of the pathology and a longitudinal axis of the proximal portion are perpendicular.

8. The uterine model of claim 1 wherein the pathology comprises a somewhat spherical shape representing a myoma.

9. The uterine model of claim 1 wherein the pathology comprises one or more elongate features representing polyps.

10. A uterine model comprising:
a first structure defining a cavity representing a uterus, said cavity at least partly defined by elastic portions that give the cavity a deflated configuration and an inflated configuration;
a second structure removably placeable within the cavity and including a component representing a pathology;
wherein when the second structure is placed within the first structure, liquid may be introduced into the cavity to inflate the cavity from the deflated configuration to the inflated configuration.

11. The uterine model of claim 10 further comprising a hole at a terminal end of the first structure and sized to receive an instrument useable for inflation of the cavity and having an imagining capability.

12. The uterine model of claim 11 wherein in said deflated configuration, a view of said pathology through the instrument is at least partially obstructed by the first structure.

13. The uterine model of claim 12 wherein in said inflated configuration, a view of said pathology through the instrument is less obstructed by the first structure than in said deflated configuration.

14. The uterine model of claim 10 wherein said second structure comprises a pathology removably connected to a housing.

15. The uterine model of claim 14 wherein the housing is threadably connectable to the first structure.

16. The uterine model of claim 10 wherein the first structure comprises a rigid portion and at least one elastic portion.

17. A method of simulating a uterine medical procedure comprising:
providing a synthetic model of a uterine cavity;
introducing an instrument into the uterine cavity;
using the instrument to inject a liquid into the cavity until the cavity expands from a deflated configuration to an inflated configuration.

18. The method of claim 17 further comprising performing a procedure within the cavity with an instrument.

19. The method of claim 18 wherein providing a synthetic model of a uterine cavity comprises including a synthetic pathology model within the cavity.

20. The method of claim 19 wherein performing the procedure within the cavity with an instrument comprises performing a procedure on the synthetic pathology model.
